(19) United States
(12) Patent Application Publication
(10) Pub. No.: US 2003/0081599 A1
(43) Pub. Date: May 1, 2003

(54) System and method for data transmission control

(76) Inventors: Chui-Tsang Wu, Chia-yi (TW); Woei-Luen Shyu, Chang-hua (TW); Cheng-Shong Wu, Taoyuan (TW); Hai-Yang Huang, Hsinchu (TW)

Correspondence Address: Finnegan, Henderson, Farabow,, Garrett & Dunner, L.L.P., 1300 I Street, N.W., Washington, DC, 20005-3315, US

(21) Appl. No.: 09/984,583

(22) Filed: Oct. 30, 2001

(51) Int. Cl. H04L 12/56

(52) U.S. Cl. 370/389; 370/412

(57) ABSTRACT

A data-transmission-control system for transmitting data packets includes a classifier to separate control packets from other packets, and an output device to transmit packets, wherein the classifier triggers the output device to directly send the separated control packets upon receiving and separating the control packets in a communication link implementing a Transmission Control Protocol, and the classifier sends the other packets to a packet processing or scheduling device.

### DESCRIPTION OF THE INVENTION

1. Field of the Invention

This invention pertains in general to systems and methods for data transmission, and more particularly, to systems and methods for improving data transmission throughput by separating control packets from other packets. More specifically, the present invention pertains to systems and methods for implementing a Transmission-Control-Protocol Control Packet Fast Forward mechanism.

2. Background of the Invention

The concept of transmitting data by delivering one or more packets containing data or control information was implemented by a known Transmission Control Protocol (“TCP”). The majority of modern network data transmission schemes, such as e-mails, the World-Wide Web (“WWW”), and the File Transfer Protocol (“FTP”), follow the TCP. The TCP is a connection-oriented protocol that provides reliable transmission of data packets between a sender and a receiver. The TCP provides a mechanism to ensure that a receiver correctly receives a packet by allowing the receiver to notify a sender of the arrival of the packet. FIG. 1 illustrates an implementation of the TCP between a sender and a receiver. The sender starts communication by sending packet 1. After the receiver receives packet 1, the receiver sends a responding packet ACK1 to the sender. ACK1 represents an “acknowledgment” packet. Upon receiving ACK1, the sender recognizes that packet 1 has been received by the receiver. To prevent lost of a data packet, the TCP operates to enable the sender to resend packet 1 if the sender does not receive ACK1 from the receiver within a certain time frame. As illustrated in FIG. 1, this traditional scheme requires the receiver to respond to the receipt of each packet with a corresponding ACK packet to the sender.

However, the traditional TCP scheme creates numerous ACK packets transmitting between the sender and the receiver that requires additional network resources to handle the traffic. Therefore, a “piggyback” scheme was proposed to allow the receiver to wait for a certain time frame and check whether the receiver has a packet other than an ACK packet that needs to be sent to the sender. If the receiver has another packet to be sent, the ACK packet is attached to that packet and transmitted to the sender. If not, the ACK packet is sent independently.

FIG. 2 illustrates the implementation of a known “piggyback” scheme under the TCP. Referring to FIG. 2, the sender transmits packet 1 to the receiver. After receiving packet 1, the receiver does not respond immediately but waits for a predetermined time frame to see whether there is any other packet that needs to be sent. If the receiver has a data packet, such as packet 3, destined for the sender, the receiver attaches an ACK1 packet to the header of packet 3. As for packet 2 sent by the sender, the receiver transmits an independent acknowledgment packet ACK2 because there is no other packet destined for the sender after the receiver has waited for the predetermined time frame. With the implementation of the piggyback scheme, the number of packets transmitted may be reduced.

Even with the piggyback scheme, however, an excessive number of acknowledgment packets may still consume network transmission resources. For a campus networking system, for example, the number of packets of 40 bytes in size makes up about one-third of the total number of packets passing through the system. Further investigation indicates that the 40-byte packets are TCP control packets, which are predominantly TCP acknowledgment packets mainly arising out of e-mails, WWW, and FTP applications because these applications employ predominantly one-way transmissions. For one-way transmissions, a receiver receives data packets from a sender without having any data packet for the sender and therefore acknowledgment packets are sent independently. These one-way transmissions create a great number of acknowledgment packets that consume network transmission resources.

In modern network systems, a Quality-of-Service (“QoS”) concept is widely implemented for data transmission control. In the last decade, the popularity of the Internet has promoted the creation of a widespread data connection network for data transmission. The expectation for data transmission has been transformed from merely having the capability to transmit to improving the efficiency and quality of data exchange. Therefore, most modern wide-band network systems support the application of the QoS concept.

The QoS concept was designed to improve the quality of communication by implementing a scheme for controlling the sequence and priority of data transmission according to the types of data being transmitted and the need for immediate data delivery, or namely, the required “quality of service” between two ends. Under the QoS concept, real-time traffic, which has more constraining requirements than other types of traffic, may be transmitted with reduced delay.

A system that implements the QoS concept generally includes, as illustrated in FIG. 3, a QoS classifier 22, one or more QoS packet queues 24, and a QoS scheduler 26. The system also includes an input device 20 for providing data packets to QoS classifier 22 and an output device 28 for transmitting the data packets from QoS scheduler 26. QoS classifier 22 classifies the data packets and sends them to QoS packet queues 24 for each class of classification. QoS scheduler 26 then determines when each data packet should be sent and schedules packet delivery accordingly.

To support a QoS scheme, network equipment implementing the scheme needs to provide additional resources, especially computational resources, to effectuate the scheme. However, the consumption of additional computational resources burdens the operation of routers with constrained resources, or with slow central processing units (“CPUs”). As a result, loss of packets may occur when the CPUs of routers are unable to process data packets in time. The application of the QoS scheme creates new problems in processing network packets.

Lakshman et al. describes a system for improved data throughput of a TCP/IP network in U.S. Pat. No. 6,078,564. Lakshman et al. implements a drop-from-front strategy for ACK packets that provides the benefit of increasing fairness of transmitting different packets and throughput when a reverse path is congested. Lakshman et al. recognizes that bandwidth needs to be reserved for the transport of ACK packets. In order to solve the congestion problem of transmitting ACK packets, Lakshman et al. preserves the most recent ACK packet by illustratively dropping an ACK packet stored at the “front/top” of a congested upstream buffer to make room for storing the most recent ACK packet. The proposed scheme prevents, at least in part, the congestion of sending ACK packets and may increase the transmission rate in a forward path.

Choudhury et al., U.S. Pat. No. 6,092,115, describes a method for supporting per-connection queuing for feedback-controlled traffic. Choudhury et al. seeks to increase the fairness in transmitting different packets and throughput when a queue is selected for dropping a packet in accordance with either the longest queue or a random drop scheme when the drop-from-front strategy is employed for ACK packets. A per-flow/connection, shared-buffer management scheme is used in conjunction with a fair queuing scheduler. One of the described embodiments implements fair-queuing-longest-queue-first and random drop methods to prevent ACK packet losses. With the proposed fair queuing, ACK packets are handled separately, preferably with separate queues and assigned transmission priorities to avoid congestion.

### SUMMARY OF THE INVENTION

Accordingly, the present invention is directed to data-transmission-control systems and methods for transmitting data packets that substantially obviate one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the systems and methods particularly pointed out in the written description and claims hereof, as well as the appended drawings.

To achieve these and other advantages, and in accordance with the purpose of the invention as embodied and broadly described, the present invention provides a data-transmission-control system for transmitting data packets that includes a classifier for separating control packets from other types of packets, and triggering an output device to directly transmit the separated control packets.

In one embodiment of the present invention, the data-transmission-control system transmits the data packets in a communication link that implements the Transmission Control Protocol.

In another embodiment, the classifier sends the other types of packets to a packet processing or scheduling device.

In yet another embodiment, the data-transmission-control system further includes a control packet queue for storing the control packets, and the classifier sends the control packets to the control packet queue after the control packets have been received and separated from the other types of packets.

Also in accordance with the present invention, there is provided a method for transmitting data packets that includes classifying the data packets, separating control packets from the other types of packets, and directly transmitting the control packets, bypassing any packet processing device.

In one embodiment of the present invention, the data-transmission-control method transmits the data packets in a communication link implementing the Transmission Control Protocol.

In an additional embodiment of the present invention, the data-transmission-control method, after separating the control packets from the other types of data packets, stores the control packets before transmitting the control packets.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate embodiments of the invention and, together with the description, serve to explain the objects, advantages, and principles of the invention.

In the drawings:

FIG. 1 illustrates an implementation of a known TCP between a sender and a receiver;

FIG. 2 illustrates an implementation of a known “piggyback” concept under the TCP;

FIG. 3 illustrates a system implementing a known “Quality-of-Service” scheme;

FIG. 4 illustrates an embodiment of the data transmission control system of the present invention;

FIG. 5 illustrates a general flow diagram for implementing one embodiment of the data-transmission-control method of the present invention;

FIG. 6 illustrates a general flow diagram for implementing another embodiment of the data-transmission-control method of the present invention;

FIG. 7 illustrates a general flow diagram for implementing an additional embodiment of the data-transmission-control method in accordance with the present invention; and

FIG. 8 illustrates a testing environment employed for a comparison test of the present invention.

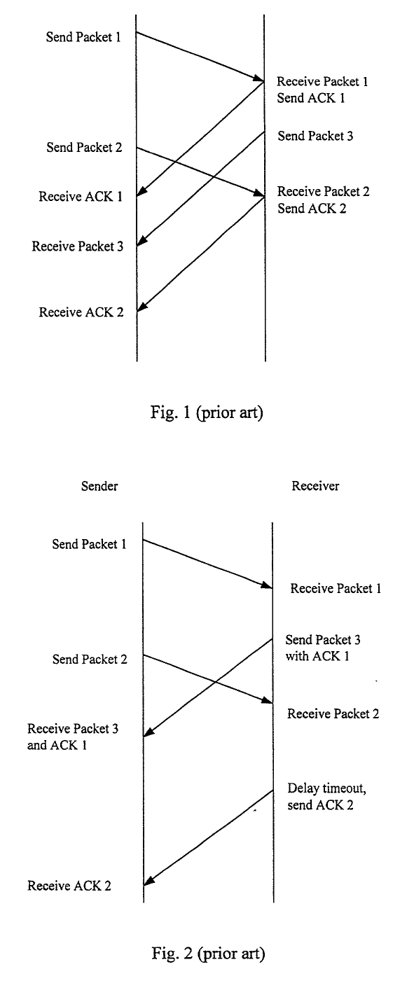

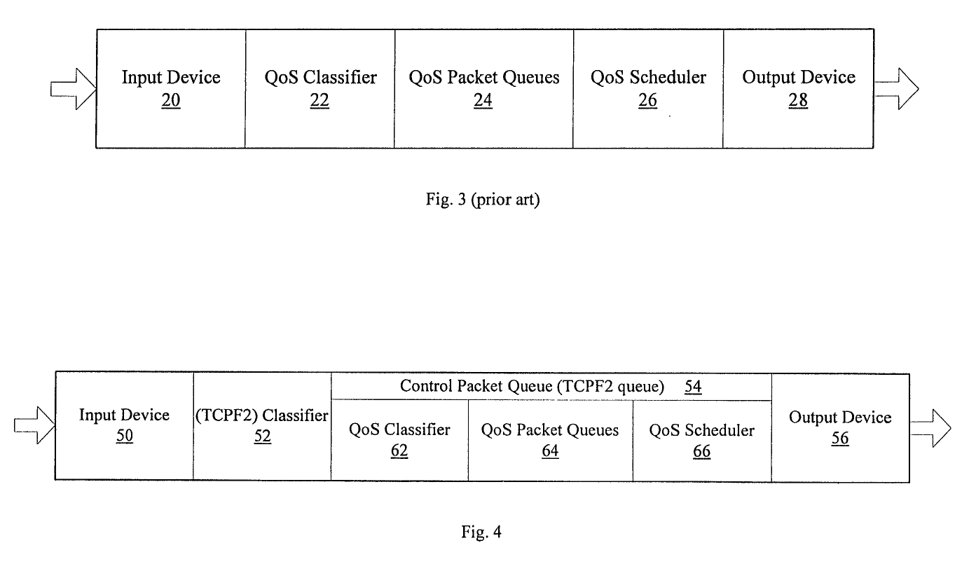

### DESCRIPTION OF THE EMBODIMENTS

The present invention provides systems and methods for data transmission control in order to transmit data packets in a communication link between a sender and a receiver. The data transmission control systems and methods generally separate control packets from other packets, such as data packets, so that the control packets are not processed by other packet processing or scheduling systems, such as a Quality-of-Service (“QoS”) processing system, in a router. In other words, the data transmission control systems and methods improve router performance by permitting direct transmission of the control packets and eliminating the corresponding processing. The systems and methods of the present invention therefore enhance the processing of data packets.

The data transmission control systems and methods of the present invention operate in a communication link that preferably implements a packet-based transmitting and connection-oriented protocol, such as the known Transmission Control Protocol (“TCP”), to further improve performance. The systems and methods of the present invention may function together with other schemes to control the sequence and priority of data transmission, such as scheduling schemes that schedule packet delivery according to the types of data being transmitted and the need for immediate data delivery as in real-time communications.

As discussed in the Background of the Invention Section, the majority of modern network systems support the Quality-of-Service (“QoS”) concept for data transmission control. For an illustration of the systems and methods of the present invention, a QoS system is used as an example of an additional parallel processing or scheduling scheme to the systems and methods of the present invention. The illustration of such an accompanying QoS system should not, however, be construed to limit the scope of the present invention.

FIG. 4 illustrates a block diagram of one embodiment of the data transmission control system of the present invention. Referring to FIG. 4, the system for controlling transmission of data packets includes a classifier 52, a control packet queue 54, and an output device 56. The system also includes an input device 50 for receiving packets that contain control signals and/or data. The data may include text, graphic, audio, and video. The system may cooperate with other schemes, such as a QoS processing system that includes a QoS classifier 62, one or more QoS packet queues 64, and a QoS scheduler 66, to control the sequence and priority of data transmission.

In operation, classifier 52 separates control packets from other types of packets and sends the other types of packets to a quality of service (“QoS”) processing device that includes QoS classifier 62 at its front end. Classifier 52 is designed to identify certain desired packets and separate these desired packets from other packets. The desired packets, in most cases, are control packets that contain only control signals specified under the TCP for control purposes and contain no data for transmission. In one embodiment of the present invention, classifier 52 only separates TCP control packets from non-TCP control packets and sends the non-TCP control packets to QoS classifier 62. Classifier 52 may separate pure TCP control packets by checking protocol identification information and the length of a packet. For example, since each packet has a protocol identification column, classifier 52 examines the protocol identification column of each packet. If a packet is a TCP packet, classifier 52 further examines the size of the TCP packet.

Since the size of the pure TCP control packets is predominantly 40 bytes, classifier 52 can separate most of the pure TCP control packets from other packets. Classifier 52 may be designed to separate packets with a size equal to or smaller than a predetermined size, for example, 40 bytes or 64 bytes. This design operates to separate all TCP control packets, plus some other types of packets having a size equal to or smaller than the predetermined size. Generally, these small packets require real-time transmission.

After classifier 52 has identified and separated the desired packets from other types of packets, classifier 52 sends the desired packets to control packet queue 54 to store these packets. Output device 56 then transmits these packets in control packet queue 54 out of the system. In one embodiment, classifier 52 triggers output device 56 to directly transmit the desired packets.

Therefore, classifier 52 is implemented and operates based on a minimum number of criteria, such as TCP protocol determination and size determination. Therefore, classifier 52 can be designed to minimize consumption of system resources and reduce the consumption of system resources by bypassing part of other packet processing or scheduling processes. Furthermore, in lieu of control packet queue 54, the present invention may be implemented by using the existing QoS packet queues 64, as shown in FIG. 4. In this particular embodiment, the system of the present invention preferably operates to separate the control packets and trigger the operation of QoS packet queues 64. An accompanying output device, such as output device 56, directly transmits the separated packets.

Among other techniques, the present invention provides the benefit of reducing the consumption of system resources. The present invention provides a “fast track” for important or high-priority packets in parallel with other processing or scheduling tracks. Therefore, the present invention processes and transmits control packets with reduced delay and improves the efficiency of other processing or scheduling schemes, such as QoS schemes. However, the advantages of classifying and separating the control packets solely based on a predetermined packet size may be minimized if a network user seeks to take advantage of the size-based approach by packing data in a packet size that falls within the predetermined size.

The present invention also provides data-transmission-control methods for transmitting data packets. One method operates in a communication link that preferably implements a packet-based transmitting and connection-oriented protocol, such as the TCP. The method controls the sequence and priority of data transmission. Ordinary packet processing or scheduling schemes schedule packet delivery according to the types of data being transmitted and the need for immediate data delivery. The following illustration uses a QoS system as an example of a processing or scheduling system that functions in parallel with the method of the present invention.

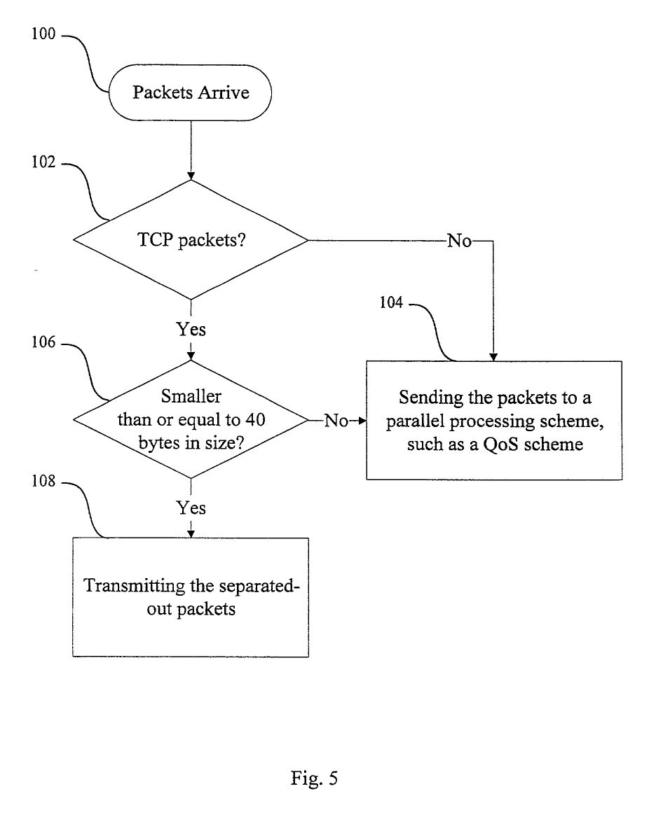

FIG. 5 illustrates a general flow diagram for implementing one embodiment of the method in accordance with the present invention. Referring to FIG. 5, data packets arrive for transmission preparation at step 100. The data packets are further classified, and the control packets are separated from other packets. In this particular embodiment, only TCP control packets are separated. At step 102, packets are determined whether they are TCP packets by the protocol identification column of each packet, since each packet has a protocol identification column. The TCP packets are separated from non-TCP packets. The non-TCP packets are sent at step 104 to a parallel packet processing or scheduling scheme, such as a QoS processing scheme.

The method includes a step 106 to separate packets smaller than or equal to 40 bytes in size. The criteria at step 106 may be set to sort out packets having a predetermined size, for example, 40 bytes, to ensure steps 102 and 106 sort out only TCP control packets. Packets that do not meet the criteria are also sent at step 104 to a parallel packet processing or scheduling scheme, such as a QoS processing scheme. The process then transmits the separated packets, which are TCP control packets, at step 108. Depending on the traffic and control of a system implementing the present invention, the transmission process may involve storing the separated packets while waiting transmission.

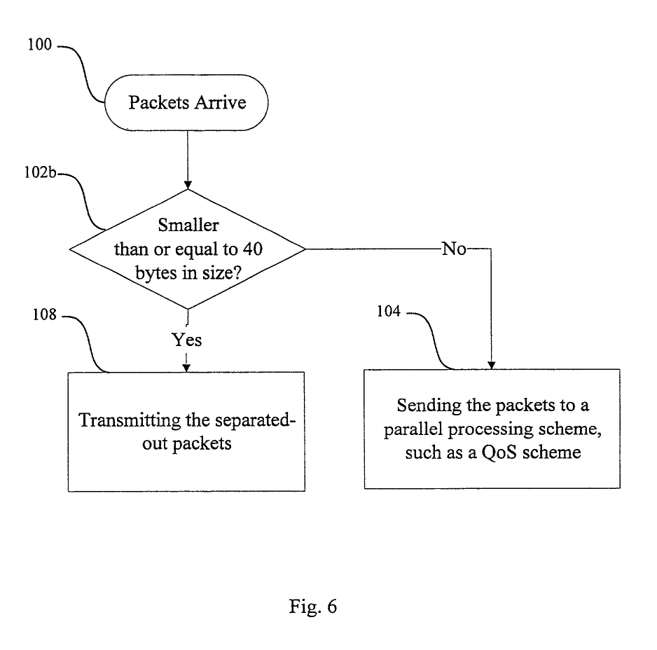

FIG. 6 illustrates a general flow diagram for implementing another embodiment of the data-transmission-control method in accordance with the present invention. Referring to FIG. 6, data packets arrive for transmission preparation at step 100. The data packets are further classified, and the control packets are separated from other packets. In this embodiment, the process simplifies the classifying process by separating control packets solely based on the size of each packet. Referring to step 102b, this embodiment separates packets of 40 bytes or smaller in size from other packets. Since the size of the pure TCP control packets is predominantly 40 bytes, this design operates to separate all TCP control packets and part of other types of 40-byte packets that usually require real-time transmission.

The other packets are sent to a parallel packet processing or scheduling scheme, such as a QoS scheme, at step 104. The process transmits the separated packets at step 108. Depending on the traffic and control of a system implementing the present invention, the transmission process may involve storing the separated packets while awaiting transmission.

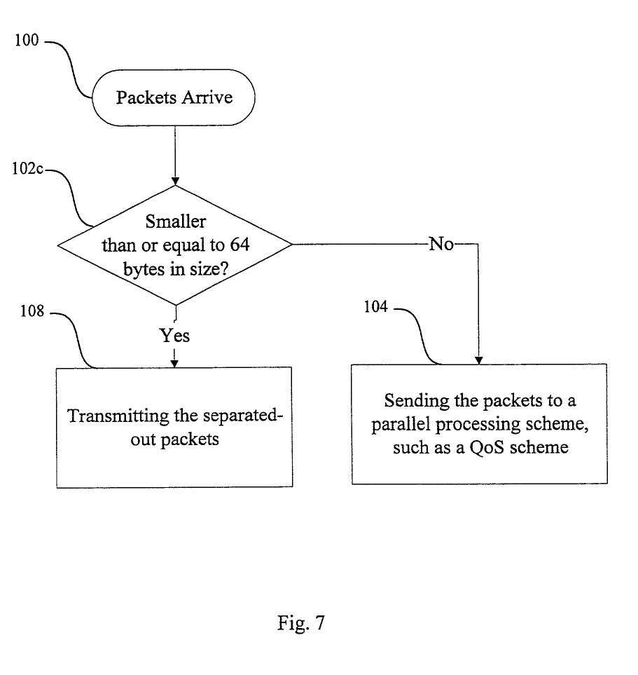

FIG. 7 illustrates a general flow diagram for implementing another embodiment of the data-transmission-control method in accordance with the present invention. As an alternative to the embodiment shown in FIG. 6, this particular embodiment employs a 64-byte packet classifying criteria. Referring to FIG. 7, data packets arrive for transmission preparation at step 100. The data packets are further classified, and the control packets are separated from other packets. Referring to step 102c, packets of 64 bytes or smaller in size are separated from other packets. Because the size of control packets and part of real-time data packets are equal to or smaller than 64 bytes, this design operates to sort out all TCP control packets and part of data packets that usually require real-time transmission. Other packets are sent to a parallel packet processing or scheduling scheme, such as a QoS scheme, at step 104. The process transmits the separated packets at step 108. Depending on the traffic and control of a system implementing the present invention, the transmission process may involve storing the separated packets while awaiting transmission.

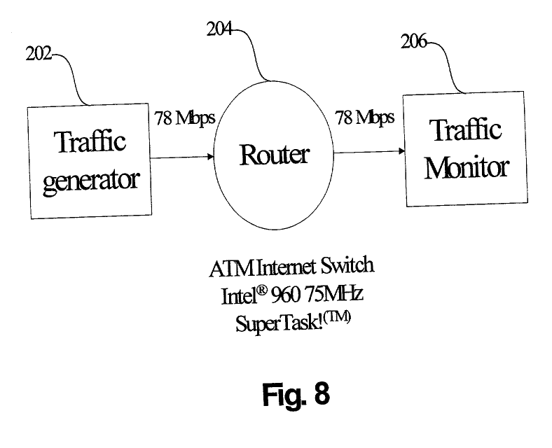

As described above, the data-transmission-control method of the present invention may be implemented in a QoS router platform to improve performance. A comparison test was conducted to observe router operations with and without the data-transmission-control method of the present invention. The comparison test provides TCP control packets of 40 bytes and non-TCP control packets of 1,100 bytes. FIG. 8 illustrates the testing environment employed in the comparison test. The testing environment includes a traffic generator 202, a router 204, and a traffic monitor 206. Referring to Table 1 below, the test result indicated that when the method of the present invention was applied, the transmission rate improved and the improvement of operational efficiency of a router is evident from the table.

TABLE 1

| | Transmission rate | Transmission |
|---|---|---|
| Ratio of data | without the method | rate with the |
| packets to TCP | of the present | method of the |
| control packets | invention | present invention |
| 1:1 | 41.0 | 62.3 |
| 2:1 | 59.4 | 78.0 |
| 3:1 | 72.9 | 78.0 |

The data-transmission-control systems and methods of the present invention first implement a classifying scheme that separates control packets from other packets and then directly transmit the control packets without consuming the processing and computation resources of a network system. The systems and methods of the present invention can be combined with other packet processing or scheduling schemes, such as a QoS scheme. Therefore, for a network system implementing a QoS scheme, the systems and methods of the present invention reduce the number of packets passing through the QoS scheme and the consumption of resources for the QoS scheme. In addition, the systems and methods of the present invention increase the efficiency of network traffic handling, especially for control packets. Therefore, the systems and methods of the present invention improve the operational efficiency of routers with constrained resources or slow CPUs, and even eliminate loss of packets.

It will be apparent to those skilled in the art that various modifications and variations can be made in the disclosed systems and methods without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A data-transmission-control system for transmitting data packets, comprising:
a classifier for separating control packets from other packets; and
an output device for transmitting the control packets and other packets, the classifier triggering the output device to send the separated control packets upon receiving and separating the control packets.

2. The data-transmission-control system as claimed in claim 1, wherein the data-transmission-control system transmits data packets in a communication link implementing a Transmission Control Protocol.

3. The data-transmission-control system as claimed in claim 1, wherein the classifier sends the other packets to a packet processing or scheduling device.

4. The data-transmission-control system as claimed in claim 1 further comprises a control packet queue for storing the control packets, wherein the classifier sends the control packets to the control packet queue upon receiving and separating the control packets.

5. The data-transmission-control system as claimed in claim 1, wherein the control packets are Transmission-Control-Protocol control packets.

6. The data-transmission-control system as claimed in claim 1, wherein the control packets are packets of a size smaller than or equal to a predetermined size.

7. The data-transmission-control system as claimed in claim 1, wherein the classifier separates only control packets, sends the separated control packets to the control packet queue, and triggers the output device to transmit the separated control packets

8. The data-transmission-control system as claimed in claim 1, wherein the classifier only separates packets of a predetermined size, sends the separated packets of the predetermined size to the control packet queue, and triggers the output device to transmit the separated packets of the predetermined size.

9. A data-transmission-control system for transmitting data packets in a communication link, comprising:
a classifier for separating control packets and for sending other packets to a packet processing or scheduling device;
a control packet queue for storing the separated control packets, the classifier sending the separated control packets to the control packet queue upon receiving and separating the control packets; and
an output device for transmitting the control packets and other packets, the classifier triggering the output device to directly transmit the separated control packets upon receiving and separating the control packets.

10. The data-transmission-control system as claimed in claim 9, wherein the communication link implements a Transmission Control Protocol.

11. The data-transmission-control system as claimed in claim 9, wherein the packet processing or scheduling device is a Quality of Service processing device.

12. The data-transmission-control system as claimed in claim 9, wherein the control packets are Transmission-Control-Protocol control packets.

13. The data-transmission-control system as claimed in claim 9, wherein the control packets are packets of a size smaller than or equal to a predetermined size.

14. The data-transmission-control system as claimed in claim 9, wherein the classifier separates only control packets, sends the separated control packets to the control packet queue, and triggers the output device to transmit the separated control packets.

15. The data-transmission-control system as claimed in claim 9, wherein the classifier separates only packets of a predetermined size, sends the separated packets of the predetermined size to the control packet queue, and triggers the output device to transmit the separated packets of the predetermined size.

16. A data-transmission-control method for transmitting data packets, comprising:
classifying the data packets;
separating control packets from other packets; and
transmitting the control packets, bypassing other packet processing or scheduling devices.

17. The data-transmission-control method as claimed in claim 16, wherein the data-transmission-control method transmits data packets in a communication link implementing a Transmission Control Protocol.

18. The data-transmission-control method as claimed in claim 16, further comprising a step of sending the other packets to a packet processing or scheduling device.

19. The data-transmission-control method as claimed in claim 16, further comprising a step of storing the separated control packets before transmitting the control packets.

20. The data-transmission-control method as claimed in claim 16, wherein the control packets are Transmission-Control-Protocol control packets.

21. The data-transmission-control method as claimed in claim 16, wherein the method separates only packets of a predetermined size in the classifying step and transmits only the packets of the predetermined size.

22. A data-transmission-control method for transmitting data packets in a communication link, comprising:
classifying the data packets;
separating control packets from other packets;
sending the other packets to a Quality of Service processing device;
storing the control packets; and
transmitting the control packets.

23. The data-transmission-control method as claimed in claim 22, wherein the communication link implements a Transmission Control Protocol.

24. The data-transmission-control method as claimed in claim 22, wherein the step of transmitting the control packets bypasses the Quality of Service processing device.

25. The data-transmission-control method as claimed in claim 22, wherein the step of separating only separates packets of a predetermined size, the step of storing only stores the packets of the predetermined size, and the step of transmitting only transmits the packets of the predetermined size.
